(19) United States
(12) Patent Application Publication
(10) Pub. No.: US 2017/0082884 A1
(43) Pub. Date: Mar. 23, 2017

(54) DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Tingze DONG, Beijing (CN); Yujia WANG, Beijing (CN); Jun MO, Beijing (CN)

(21) Appl. No.: 15/091,026

(22) Filed: Apr. 5, 2016

(30) Foreign Application Priority Data
Sep. 23, 2015 (CN) 201510613284.6

(51) Int. Cl. G02F 1/1339; G02F 1/1335

(52) U.S. Cl. CPC G02F 1/13394; G02F 1/133514; G02F 2001/13396

(57) ABSTRACT

A display panel and a display device are provided. The display panel includes: a color filter substrate and an array substrate which are cell-assembled together, spacers disposed between the color filter substrate and the array substrate, the spacers include a plurality of primary spacers; a distribution density of the primary spacers in the display edge area is larger than a distribution density of the primary spacers in the display central area and larger than a density of the primary spacers in the display middle area.

### TECHNICAL FIELD

Embodiments of the present disclosure relate to a display panel and a display device.

### BACKGROUND

In a process of the preparation of a liquid crystal panel, a color filter substrate and an array substrate are cell-assembled together to obtain a display panel to implement the preliminary configuration, after cell-assembling the display panel still needs undergo the processes of modifying, plating, polishing and so on. However, in the processes such as the preparation process after cell-assembling, the later process of transportation of display panels and the like, a relative displacement is easy to occur between the edge area of a color filter substrate and the edge area of an array substrate, it is easy to cause some friction between a spacer and a thin film transistor, and the spacer is interposed between the color filter substrate and the array substrate. The friction is easy to produce fragment of an alignment film, and further the bright defect occurs in the display panel. Because the bright defect is usually gathered at the edge of the display panel and present in a linear mode, the defect is usually named as a line zara, and the line zara seriously influences the image quality of final display products.

### SUMMARY

An embodiment of the present disclosure provides a display panel which includes: a color filter substrate and an array substrate which are cell-assembled together, a spacer disposed between the color filter substrate and the array substrate and including a plurality of primary spacers; an area located between the color filter substrate and the array substrate includes a display central area, a display middle area surrounding the display central area, and a display edge area surrounding the display middle area; a distribution density of the primary spacers in the display edge area is larger than a distribution density of the primary spacers in the display central area, and larger than a distribution density of the primary spacers in the display middle area.

An embodiment of the present disclosure provides a display device, and the display device includes the above-mentioned display panel.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1 is a cross section structure schematic view of a display panel provided by an embodiment of the present disclosure;

FIG. 2 is a stereoscopic structure schematic view of a display panel provided by an embodiment of the present disclosure; and

FIG. 3 is a flat structure schematic view of a display panel provided by an embodiment of the present disclosure.

### DETAILED DESCRIPTION

The technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

The embodiments of the present disclosure provide a display panel and a display device, and the Line Zara defect is less likely to occur in the display panel, the picture quality is improved.

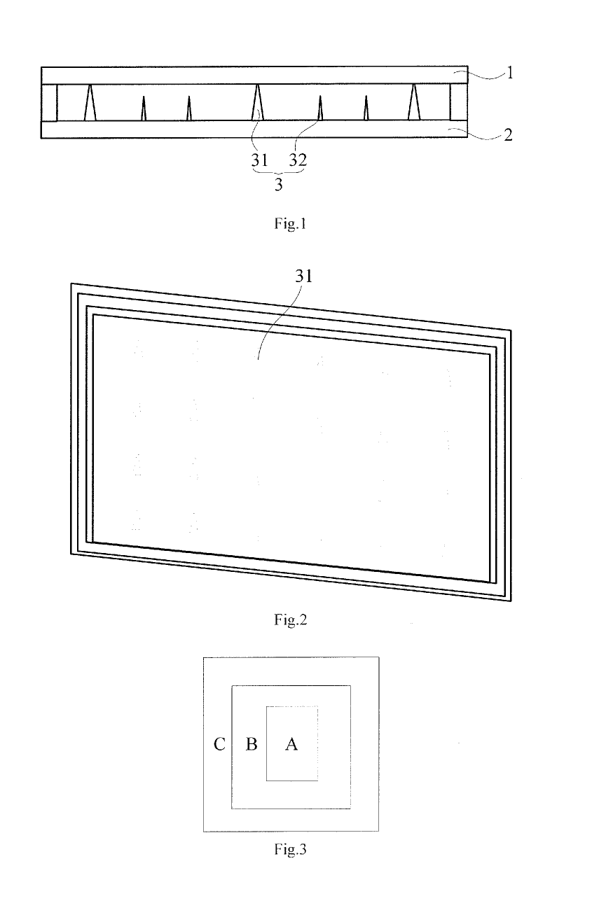

As shown in FIG. 1 to FIG. 3, a display panel provided by an embodiment of the present disclosure includes: a color filter substrate 1 and an array substrate 2 which are cell-assembled together, and spacers 3 which are disposed between the color filter substrate 1 and the array substrate 2 and include at least one primary spacer 31;

As shown in FIG. 2, an area located between the color filter substrate 1 and the array substrate 2 comprises: a display central area A, a display middle area B surrounding the display central area A, and a display edge area C surrounding the display middle area B;

The distribution density of the primary spacers 31 (for example the number of the spacers in per unit area) in the display edge area C is larger than the distribution density of the primary spacers 31 in the display central area A, and larger than the distribution density of the primary spacers 31 in the display middle area B.

In a display panel, the spacers disposed between the color filter substrate and the array substrate mainly play a role of supporting, meanwhile, the top end and the bottom end of a primary spacer are connected with the color filter substrate and the array substrate respectively, thus it can produce friction with the color filter substrate as well as the array substrate to prevent the relative displacement between the color filter substrate and the array substrate.

In a display panel of an embodiment of the present disclosure, the distribution density of the primary spacers 31 in the display edge area C is larger than the distribution density of the primary spacers 31 in the display central area A, and larger than the distribution density of the primary spacers 31 in the display middle area B as well, that is the number of the primary spacers 31 in the edge area C of the display panel is more. Therefore, the color filter substrate 1 and the array substrate 2 in the edge area C of the display panel burden a larger frictional force from the primary spacers 31. Therefore, in a display panel of the embodiment of the present disclosure, the relative displacement is less likely to occur in the edge portion(s) of the color filter substrate 1 and the array substrate 2. Therefore, the line zara defect is less likely to occur in the display panel of the embodiment, and the picture quality becomes good.

As shown in FIG. 1 to FIG. 3, in a specific embodiment, the spacers 3 include a plurality of primary spacers 31, the distribution density of the primary spacers 31 in the display middle area B is larger than the distribution density of the primary spacers 31 in the display central area A, that is from the display middle area B to the display edge area C, the distribution density of the primary spacers 31 becomes bigger and bigger. The closer to the edge of the display panel, more likely the line zara defects occur, so the bigger the distribution density of the primary spacers 31 from the display middle area B to the display edge area C, the larger the friction the areas of the color filter substrate 1 and the array substrate 2 closer to the edge of the display panel suffers from due to the primary spacers 31, and further the relative displacement is less likely to occur between the color filter substrate 1 and the array substrate 2; therefore, the line zara defects are less likely to occur throughout the whole display panel.

In an embodiment of the present disclosure, for example, as shown in FIG. 3, on the basis of the above mentioned position relationships among the areas A, B and C, the length and the width of the display central area A may be 1/4 to 3/4 of the length and the width of the display edge area C, and the length and the width of the display middle area B may be 1/2 to 7/8 of the length and the width of the display edge area C.

As shown in FIG. 1 to FIG. 3, on the basis of the above-mentioned embodiments, in an embodiment of the present disclosure, the distribution density of the primary spacers 31 in the display central area A, the distribution density of the primary spacers 31 in the display middle area B, and the distribution density of the primary spacers 31 in the display edge area C are increased linearly in sequence. In another embodiment, in the display central area A, along the direction from the center of this area to the edge of this area, the distribution density of the primary spacers 31 is increased linearly; in the display middle area B, along the direction from the inner edge of this area to the outer edge of this area, the distribution density of the primary spacers 31 is increased linearly; in the display edge area C, along the direction from the inner edge of this area to the outer edge of this area, the distribution density of the primary spacers 31 is increased linearly.

The above-mentioned setting modes of the distribution density of the primary spacers 31 in each area can make the distribution density of the primary spacers 31 from the central to the edge of the display panel increase, that is, make the distribution density variation of the primary spacers 31 more uniform, and further the relative displacement is less likely to occur between the color filter substrate 1 and the array substrate 2; therefore, the line zara defects arc less likely to occur throughout the whole display panel.

As shown in FIG. 3, on the basis of the above-mentioned embodiments, in a specific embodiment, the outer edge of the display central area A, the outer edge of the display middle area B, the outer edge of the display edge area C are in a rectangular shape or a quasi-rectangular shape.

On the basis of the above-mentioned embodiments, in an embodiment, the distribution density of the primary spacers 31 in the display central area A is 1/72 (i.e., every 72 sub-pixels correspond to one primary spacers); the distribution density of the primary spacers 31 in the display middle area B is 1/36 (i.e., every 36 sub-pixels correspond to one primary spacers); the distribution density of the primary spacers 31 in the display edge area C is 1/24 (i.e., every 24 sub-pixels correspond to one primary spacers).

As shown in FIG. 1, on the basis of the above-mentioned embodiments, in a specific embodiment, the spacers 3 between the color filter substrate 1 and the array substrate 2 further include a plurality of auxiliary spacers 32. The auxiliary spacers 32 has a smaller height compared with the primary spacers 31, and their top ends may not contact with the surface of the substrate they are opposite to in the situation that the display panel is not pressed by an external force. In order not to influence the aperture ratio of the display panel, all the spacers 3 are usually disposed within the black matrix area, therefore, the location and space which are used to dispose the spacers is limited; however, in the embodiment of the present disclosure, by disposing the primary spacers in the location where the auxiliary spacers would be originally disposed to increase the distribution density of the primary spacers. For example, the setting of the auxiliary spacers in the embodiments of the present disclosure has the following methods.

### First Method

In the case that the distribution density of the primary spacers 31 in the display edge area C is larger than the distribution density of the primary spacers 31 in the display central area A and also larger than the distribution density of the primary spacers 31 in the display middle area B, the distribution density of the auxiliary spacers 32 in the display edge area C is smaller than the distribution density of the auxiliary spacers 32 in the display central area A and also smaller than the distribution density of the auxiliary spacers 32 in the display middle area B.

### Second Method

In the case that the distribution density of the primary spacers 31 in the display edge area C is larger than the distribution density of the primary spacers 31 in the display middle area B, and the distribution density of the primary spacers 31 in the display middle area B is larger than the distribution density of the primary spacers 31 in the display central area A, the distribution density of the auxiliary spacers 32 in the display edge area C is smaller than the distribution density of the auxiliary spacers 32 in the display middle area B, and the distribution density of the auxiliary spacers 32 in the display middle area B is smaller than the distribution density of the auxiliary spacers 32 in the display central area A.

### Third Method

In the case that the distribution density of the primary spacers 31 in the display central area A, the distribution density of the primary spacers 31 in the display middle area B, and the distribution density of the primary spacers 31 in the display edge area C are increased linearly in sequence, the distribution density of the auxiliary spacers 32 in the display central area A, the distribution density of the auxiliary spacers 32 in the display middle area B, and the distribution density of the auxiliary spacers 32 in the display edge area C are decreased linearly in sequence.

### Fourth Method

In the case that in the display central area A, along the direction from the center of this area to the edge of this area, the distribution density of the primary spacers 31 is increased linearly; in the display middle area B, along the direction from the inner edge of this area to the outer edge of this area, the distribution density of the primary spacers 31 is increased linearly; in the display edge area C, along the direction from the inner edge of this area to the outer edge of this area, the distribution density of the primary spacers 31 is increased linearly; in this case, in the display central area A, along the direction from the center of this area to the edge of this area, the distribution density of the auxiliary spacers 32 is decreased linearly; in the display middle area B, along the direction from the inner edge of this area to the outer edge of this area, the distribution density of the auxiliary spacers 32 is decreased linearly; in the display edge area C, along the direction from the inner edge of this area to the outer edge of this area, the distribution density of the auxiliary spacers 32 is decreased linearly.

Of course, the setting of the auxiliary spacers 32 in the embodiments of the present disclosure is not limited to the above-mentioned modes or methods, in the case that the positions used for setting the spacers is enough to meet the distribution density setting of the primary spacers, the distribution density of the auxiliary spacers in each area may also be the same.

On the basis of the above-mentioned embodiments, in another specific embodiment of the present disclosure, the spacers 3 are disposed on the color filter substrate 1; or the spacers 3 are disposed on the array substrate 2; or the spacers 3 can be disposed on both the color filter substrate and the array substrate.

An embodiment of the present disclosure further provides a display device, the display device includes the display panel according to any one of the display panel in the above-mentioned embodiments. In the display device, the relative displacement is less likely to occur between the color filter substrate and the array substrate; therefore, the line zara defects are less likely to occur throughout the whole display panel, and the picture quality of the display device is good.

What are described above is related to the illustrative embodiments of the disclosure only and not limitative to the scope of the disclosure; the scopes of the disclosure are defined by the accompanying claims.

The present application claims the benefits of Chinese patent application No. 201510613284.6, which was filed with the SIPO on Sep. 23, 2015 and is fully incorporated herein by reference as part of this application.

What is claimed is:

1. A display panel, comprising:
a color filter substrate and an array substrate which are cell-assembled together,
spacer disposed between the color filter substrate and the array substrate and comprising a plurality of primary spacers; wherein,
an area located between the color filter substrate and the array substrate comprises: a display central area, a display middle area surrounding the display central area, and a display edge area surrounding the display middle area;
a distribution density of the primary spacers in the display edge area is larger than a distribution density of the primary spacers in the display central area and also larger than a distribution density of the primary spacers in the display middle area.

2. The display panel according to claim 1, wherein the distribution density of the primary spacers in the display middle area is larger than the distribution density of the primary spacers in the display central area.

3. The display panel according to claim 2, wherein the distribution density of the primary spacers in the display central area, the distribution density of the primary spacers in the display middle area, and the distribution density of the primary spacers in the display edge area are increased linearly in sequence.

4. The display panel according to claim 2, wherein in the display central area, along a direction from a center of the display central area to an edge of the display central area, the distribution density of the primary spacers is increased linearly.

5. The display panel according to claim 4, wherein in the display middle area, along a direction from an inner edge of the display middle area to an outer edge of the display middle area, the distribution density of the primary spacers is increased linearly.

6. The display panel according to claim 5, wherein in the display edge area, along a direction from an inner edge of the display edge area to an outer edge of the display edge area, the distribution density of the primary spacers is increased linearly.

7. The display panel according to claim 2, wherein an edge of the display central area, an outer edge of the display middle area, and an outer edge of the display edge area are in a rectangular shape or a quasi-rectangular shape.

8. The display panel according to claim 7, wherein the distribution density of the primary spacers in the display central area is 1/72; the distribution density of the primary spacers in the display middle area is 1/36; the distribution density of the primary spacers in the display edge area is 1/24.

9. The display panel according to claim 1, wherein the spacers further comprise a plurality of auxiliary spacers;
a distribution density of the auxiliary spacers in the display edge area is smaller than a density of the auxiliary spacers in the display central area and also smaller than a distribution density of the auxiliary spacers in the display middle area.

10. The display panel according to claim 2, wherein the spacers further comprise a plurality of auxiliary spacers;
a distribution density of the auxiliary spacers in the display edge area is smaller than a density of the auxiliary spacers in the display central area and also smaller than a distribution density of the auxiliary spacers in the display middle area.

11. The display panel according to claim 3, wherein the spacers further comprise a plurality of auxiliary spacers;
a distribution density of the auxiliary spacers in the display edge area is smaller than a density of the auxiliary spacers in the display central area and also smaller than a distribution density of the auxiliary spacers in the display middle area.

12. The display panel according to claim 4, wherein the spacers further comprise a plurality of auxiliary spacers;
a distribution density of the auxiliary spacers in the display edge area is smaller than a density of the auxiliary spacers in the display central area and also smaller than a distribution density of the auxiliary spacers in the display middle area.

13. The display panel according to claim 5, wherein the spacers further comprise a plurality of auxiliary spacers;
a distribution density of the auxiliary spacers in the display edge area is smaller than a density of the auxiliary spacers in the display central area and also smaller than a distribution density of the auxiliary spacers in the display middle area.

14. The display panel according to claim 6, wherein the spacers further comprise a plurality of auxiliary spacers;
a distribution density of the auxiliary spacers in the display edge area is smaller than a density of the auxiliary spacers in the display central area and also smaller than a distribution density of the auxiliary spacers in the display middle area.

15. The display panel according to claim 11, wherein the distribution density of the auxiliary spacers in the display central area, the distribution density of the auxiliary spacers in the display middle area, and the distribution density of the auxiliary spacers in the display edge area are decreased linearly in sequence.

16. The display panel according to claim 12, wherein in the display central area, along the direction from the center of the display central area to the edge of the display central area, the distribution density of the auxiliary spacers is decreased linearly.

17. The display panel according to claim 13, wherein in the display middle area, along the direction from the inner edge of the display middle area to the outer edge of the display middle area, the distribution density of the auxiliary spacers is decreased linearly.

18. The display panel according to claim 14, wherein in the display edge area, along the direction from the inner edge of the display edge area to the outer edge of the display edge area, the distribution density of the primary spacers is decreased linearly.

19. The display panel according to claim 9, wherein the spacers are disposed on the color filter substrate; or the spacers are disposed on the array substrate.

20. A display device, comprising the display panel according to claim 1.
